(19) United States
(12) Patent Application Publication
(10) Pub. No.: US 2015/0359228 A1
(43) Pub. Date: Dec. 17, 2015

(54) Insect Biocontrol Method and Device: Attract-Infect-Release (AIR) Technology

(71) Applicants: Ying Zhang Grasso, Beachwood, OH (US); Hong Jiang, Wuhan (CN); Jun-Ping Wang, Qingdao (CN); Yu-Long Cheng, Anji (CN); Yan-Lai Zhou, Anji (CN)

(72) Inventors: Ying Zhang Grasso, Beachwood, OH (US); Hong Jiang, Wuhan (CN); Jun-Ping Wang, Qingdao (CN); Yu-Long Cheng, Anji (CN); Yan-Lai Zhou, Anji (CN)

(21) Appl. No.: 14/272,447

(22) Filed: Jun. 12, 2014

(51) Int. Cl. A01N 63/00; A01M 1/10; A01M 1/20; A01M 1/02; A01M 1/04

(52) U.S. Cl. CPC A01N 63/00; A01M 1/026; A01M 1/04; A01M 1/2022; A01M 1/106

(57) ABSTRACT

A pest biocontrol method and device for flying insects configured to be used with solar power is disclosed. The device includes a solar panel, a solar rechargeable battery pack, a solar charge controller, an insect-attracting lamp and/or a semiochemical vial, and a biopesticide-spraying device. This biocontrol device can be used with or without a trap fan to draw in insects, and an exit fan that draws out infected insects to be released. The said device accomplishes AIR (Attract-Infect-Release) method of insect biocontrol.

### TECHNICAL FIELD OF THE INVENTION

The present invention relates to the art of insect control devices, and to the particular field of insect biocontrol devices.

### BACKGROUND OF THE INVENTION

Biocontrol or biological control of insects is a strategy that utilizes pests' natural enemies for their suppression. These natural enemies may include predators, parasites, and microorganisms such as insect bacteria, fungi and viruses. Biocontrol is an important component of agriculture and forestry that practice “integrated pest management”. Some successful biocontrol examples include: 1) The suppression of Winter moths (Operophtera brumata). In Canada, these insects are pests of forest and shade trees. They have been successfully controlled by Cyzenis albicans (a tachinid fly) and Agrypon flaveolatum (an ichneumonid wasp). 2) The suppression of Cereal leaf beetles (Oulema melanopus). This species is a pest of small grains in the Midwestern U.S. Its eggs are attacked by a mymarid wasp (Anaphes flavipes), its larvae are parasitized by a eulophid wasp (Tetrastichus julis), and adults are susceptible to a fungal pathogen (Beauveria bassiana).

Biocontrol of insects is becoming increasingly important because the widely used chemical insecticides are causing a multitude of environmental, food safety and health problems. The pathogenic microorganisms used in biocontrol, such as insect bacteria, fungi and viruses are referred to as biopesticides. The advantages of biocontrol are: 1) biopesticides are less toxic than chemical pesticides; 2) biopesticides are insect species-specific, i.e. they will not harm other animals, humans, or different insects; 3) biopesticides do not need to be reapplied as often as chemical pesticides, and they can be effective in small quantities.

When targeted insects ingest or come into contact with specific biopesticides, they become the host for the multiplication of these pathogenic microorganisms, which ultimately lead to their death. Because insects are social beings, the infected insects spread these pathogenic microorganisms through social activities such as feeding and mating. After the infected insects are killed, their carcasses become a pool of the biopesticides, which can cause further infection and killing. The effect of biopesticide can have a latency period of 5-7 days. Once the infection starts, it has a snowball effect, which eventually leads to the suppression of a particular pest insect.

The US Environmental Protection Agency regulates biopesticides. It performs an extensive review of health and safety information to ensure that the use of a particular biopesticide does not pose unreasonable risks or harm to human health and the environment. Progress in the development of biopesticides has made it possible to practice biocontrol on a large scale. There are commercially-available suspensions of fungus spores, or virus particles that can be sprayed onto crops in a manner similar to chemical insecticides.

Semiochemicals are compounds that insects secrete to communicate with each other. They play a major role in delivering behavioral messages. Some semiochemicals may be attractants or repellents, some may stimulate or inhibit feeding, some may direct flight or inhibit it. The most frequently-used semiochemicals in insect biocontrol are insect sex pheromones. They have been utilized successfully in the mass trapping of sexually active adult male insects, in order to reduce population density and to lower the pest's reproductive potential. Many semiochemicals have been isolated from their natural source or chemically synthesized, and therefore are commercially available.

### PRIOR ART

In U.S. Pat. No. 5,359,807 A, Method and Apparatus for Autodissemination of Insect Pathogens, a flying insect is lured into a trap by an attractant, it crawls through a space which contains biopesticide by the design configuration, and eventually exits from another end to escape.

In U.S. Pat. No. 5,189,831 A, A Method and Device for the Biological Control of Insects, an insect is lured into a cone-shaped trap by an attractant, it drops into a chamber containing biopesticide to be infected, and escapes from an exit.

In U.S. Pat. No. 5,452,540 A, Autoinoculating Device for Contaminating Insects with Active Agents, an insect enters from the top of a funnel drop-type trap, it drops to the chamber containing biopesticide by gravity, and eventually exits from the side of the chamber.

The prior art profile indicates the existence of several insect biocontrol devices. However, the novel aspects and advantages of this invention are:

1. it is solar powered,

2. it actively lures target insects with an insect-attracting lamp, with semiochemicals, or with both, and then draws them in with a gentle trap fan,

3. it has a sprayer which actively sprays biopesticide on the targeted insects,

4. it uses a motor fan to actively draw out infected insects for release to cause further infection,

5. the combination of 1-4 is hitherto unknown.

### DETAILED DESCRIPTION OF THE INVENTION

All components of the device are readily commercially-available. It is their combination to be used as a biocontrol device to achieve “Attract-Infect-Release” (AIR) technology that is hitherto unknown.

As shown in drawings “FIG. 1” and “FIG. 2”, solar panel 1 generates power, which recharges battery pack 2. Solar charge controller 3 regulates the recharging of battery pack 2, distributes power to and controls the on/off times of insect-attracting lamp 4, trap fan 5 (only in FIG. 1), exit fan 8 (only in FIG. 1), and biopesticide sprayer 7. Target insect is attracted by either lamp 4 or semiochemical 6, and drawn into the device by trap fan 5 (only in FIG. 1). Sprayer 7 sprays biopesticide onto trapped insects. Infected insects are drawn out of the device by an exit fan 8 (only in FIG. 1). All components 1-8 are supported by frame 9.

There are two ways the said device can function, one with fans, another without.

With fans, as in drawing “FIG. 1”:

1. As targeted insects are attracted to the vicinity of the AIR device via insect-attracting lamp 4 and/or semiochemicals 6, the trap fan 5 gently draws them into the device.
I. Trap fan 5 is contained in fine yet sturdy mesh, which denies passage of insects through fan,
II. Trap fan 5 creates a gentle vortex to draw in insects through the space surrounding the fan.

2. Insects enter the chamber containing the biopesticide sprayer 7.

3. Sprayer 7 is has a built-in timer which enables it to turn on for a certain period of time at regular intervals to spray biopesticide onto trapped insects.

4. After a certain period of time, the sprayer 7 turns off, and the infected insects are gently drawn out of the device by exit fan 8. These infected insects are the new hosts of pathogenic microorganisms to cause further infection and the suppression of the pest insect population.
I. Exit fan 8 is contained in fine yet sturdy mesh, which denies passage of insects through fan,
II. Exit fan 8 creates a gentle vortex to draw out insects through the space surrounding the fan.

Without fans, as in drawing “FIG. 2”:

1. Targeted insects are attracted to the vicinity of the AIR device via insect-attracting lamp 4, and/or semiochemicals 6. Lamp 4 has a timer to turn on and off at certain times

2. Biopesticide sprayer 7 turns on to spray the area around lamp 4, and/or semiochemicals 6.
I. Sprayer 7 has a timer to turn on and off at certain times,
II. Sprayer 7 sprays for a length of time, to ensure coverage of the insects,

3. Lamp 4 and sprayer 7 both turn off at the same time to allow complete dispersion of infected insects.

After a certain time interval, lamp 4 turns on again to begin another cycle of insect-attraction, infection, and release.

### BRIEF DESCRIPTION OF THE DRAWINGS

FIG. 1 is an exploded view of an AIR device with fans as described in [0014], [0015], [0016], [0017], [0018].

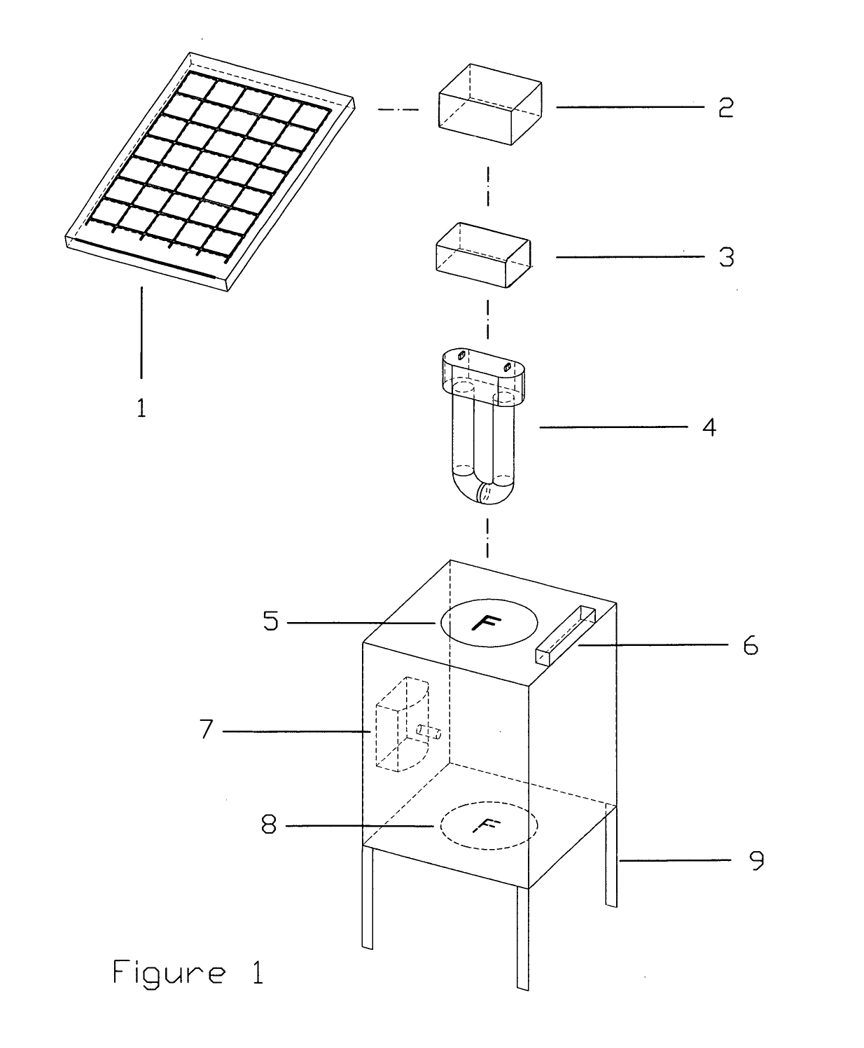

FIG. 2 is an exploded view of an AIR device without fans as described in [0019], [0020], [0021], [0022], [0023].

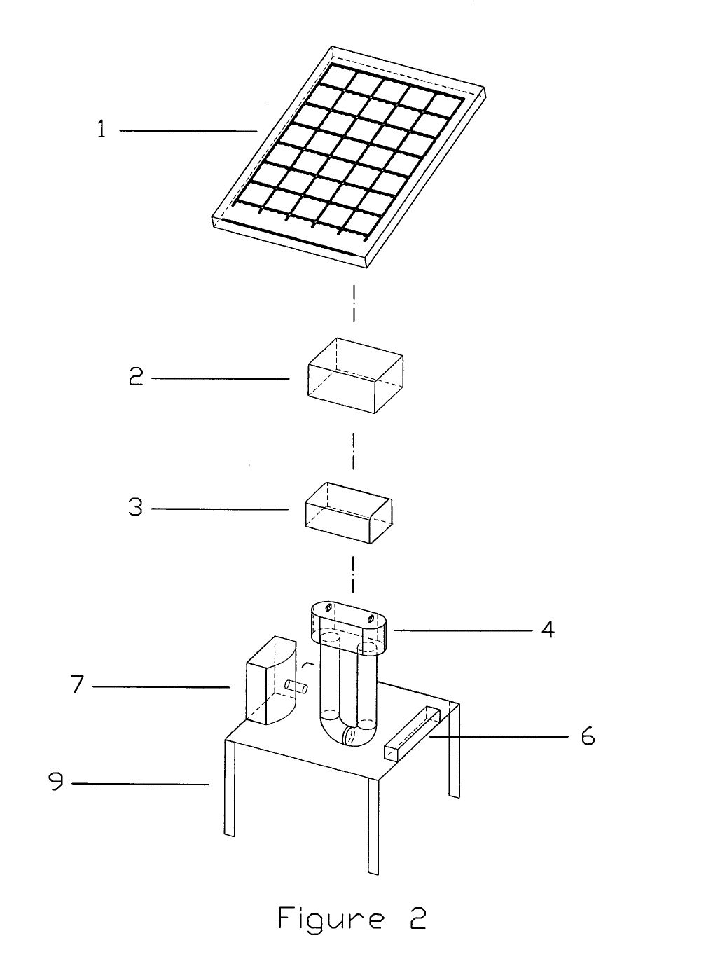

1. A method of insect biocontrol: AIR (Attract-Infect-Release) method of insect biocontrol, whereby “Attract” being attracting targeted insects using an insect-attracting lamp and/or insect-specific semiochemicals; “Infect” being infecting targeted insects with insect-specific insecticidal microorganisms, such as insect viruses, insect fungi, and insect bacteria; “Release” being releasing infected insects to their own habitat to further infect other insects.

2. An insect biocontrol device based on AIR method wherein the improvement comprises of a combination of solar power, an insect-attracting lamp and/or a semiochemical-containing vial to attract targeted flying insects, and a spraying apparatus capable of spraying insect-specific insecticidal microorganisms in either suspension or powder form.

3. An insect biocontrol device wherein the improvement comprises of using either a trap fan capable of drawing in attracted insects, and an exit fan to draw out microorganism-infected insects to be released; or a design allowing for ease of insect entry and microorganism-infected insect escape from the device.
